(19) United States
(12) Patent Application Publication
(10) Pub. No.: US 2024/0364423 A1
(43) Pub. Date: Oct. 31, 2024

(54) WAVEFRONT CORRECTION FOR FREE-SPACE OPTICAL COMMUNICATIONS

(71) Applicant: University of Central Florida Research Foundation, Inc., Orlando, FL (US)

(72) Inventor: Guifang LI, Orlando, FL (US)

(21) Appl. No.: 18/612,433

(22) Filed: Mar. 21, 2024

Related U.S. Application Data
(60) Provisional application No. 63/491,300, filed on Mar. 21, 2023.

(51) Int. Cl. H04B 10/112; H04B 10/079; H04B 10/61

(52) U.S. Cl. CPC H04B 10/1121; H04B 10/07953; H04B 10/6165

(57) ABSTRACT

A system and method for wavefront correction is achieved using an adaptive optics photonic integrated circuit with monitoring per stage. The method begins with receiving a single optical data signal contained in a distorted wavefront, wherein a single optical signal is divided into a plurality of parts, each representing a unique propagation path through free space, wherein the plurality of parts of the single optical signal is received by a programmable optical processor consisting of cascaded Mach-Zehnder Interferometers (MZi) each with a first phase shifter and a second phase shifter. Next, the settings are adjusted of each of the first phase shifter and the second phase shifter until the plurality of parts of the single optical signal are combined into one output of a last MZi, wherein the settings of the first phase shifter and the setting of the second phase shifter of each MZi are controlled by independent measurements.

### CROSS-REFERENCE TO RELATED APPLICATIONS

This application claims priority from and is related to U.S. Provisional Patent Application Ser. No. 63/491,300, entitled “Wavefront Correction For Free-Space Coherent Optical Communications” with attorney docket number 2023-066-011/461-P0047, filed on Mar. 21, 2023, which is hereby incorporated into the present application by reference in its entirety.

### FEDERALLY SPONSORED RESEARCH AND DEVELOPMENT

N/A

### BACKGROUND

The present application generally relates to free-space optical communications and, more particularly, to free-space coherent optical communications.

This application includes references denoted in brackets with numbers, e.g., [x], where x is a number. This numeric listing of the references is found at the end of this application. Further, these references are listed in the information disclosure statement (IDS) filed herewith. The teachings of each of these listed references is hereby incorporated hereinto by reference in their entirety.

Atmospheric turbulence distorts the wavefront of the signal in free-space optical (FSO) communication, which results in amplitude and phase error at the detector [1]. To mitigate this problem, adaptive optics in conjunction with wavefront sensors and feedback controls have been used for wavefront correction [1]. To eliminate costly and slow adaptive optics, arrayed incoherent receivers have been investigated for FSO communication [2]. Furthermore, coherent optical arrayed receivers for PPM (pulse-position modulation) signals in FSO communication have been proposed [3]. Recently, DSP assisted carrier phase estimation has been demonstrated for phase-shift keying (PSK) signals [4]. The technique has been extended to wavefront correction for free-space coherent optical communications by using coherent arrayed receivers.

### SUMMARY OF THE INVENTION

Disclosed is an adaptive optics photonic integrated circuit for wavefront correction with monitoring per stage. More specifically, disclosed is a method and system for waveform correction that begins with receiving a single optical data signal contained in a distorted wavefront, wherein a single optical signal is divided into a plurality of parts, each representing a unique propagation path through free space, wherein the plurality of parts of the single optical signal is received by a programmable optical processor consisting of cascaded Mach-Zehnder Interferometers (MZi) each with a first phase shifter and a second phase shifter.

Next, the settings are adjusted of each of the first phase shifter and the second phase shifter until the plurality of parts of the single optical signal are combined into one output of a last MZi, wherein the settings of the first phase shifter and the setting of the second phase shifter of each MZi are controlled by independent measurements.

In one example, the settings of the first phase shifter are controlled by balancing the outputs of a first 2×2 coupler, and the settings of the second phase shifter are controlled by minimizing the outputs of an undesired port of a second 2×2 coupler.

In another example, the first phase shifter and the second phase shifter are thermal phase shifters.

Also disclosed is a method and system for waveform correction that begins with receiving a single optical signal contained in a distorted wavefront, wherein the single optical signal is further divided into a plurality of parts (optical) and then mixed with a coherent local oscillator or is mixed with a common local oscillator and then divided into a plurality of parts, each representing a unique propagation path through free space, wherein the plurality of parts (electrical) after mixing are photodetected to yield a plurality of electrical signals preserving complex amplitudes of the plurality of parts of the single optical signal. The plurality of electrical signals preserving the complex amplitudes of the plurality of parts of the single optical signal is received by a digital signal processing (DSP) unit representing a unitary matrix wherein the plurality of electrical signals preserving the complex amplitudes of the plurality of parts of the single optical signal are combined into one signal.

In one example, the DSP unit is a digital representation of a programmable optical processor consisting of cascaded Mach-Zehnder Interferometers (MZi), each with a first phase shifter and a second phase shifter. The settings of the first phase shifter and the second phase shifter are adjusted until the plurality of electrical signals preserving complex amplitudes of the plurality of parts of the single optical signal is combined into one output of a last MZi, wherein the settings of the first phase shifter and the setting of the second phase shifter of each MZi are controlled by independent measurements.

In another example, the settings of the first phase shifter is controlled by balancing the outputs of a first 2×2 coupler, and the settings of the second phase shifter is controlled by minimizing the outputs of an undesired port of a second 2×2 coupler.

Still, further disclosed is a method and system for waveform correction that begins with receiving a single optical data signal representing a wavefront traveling along a plurality of propagation paths through free space, wherein the single optical data signal is received at a balanced photodetector array. In one example, the single optical pilot signal is sent with low additional power as compared with the single optical data signal. In another example, the single optical pilot signal is sent at a lower baud rate as compared with the single optical data signal

Next, a single optical pilot signal is received, representing control of the single optical data signal. The phase error is removed electronically in the received single optical data signal that is a result of the travel through free space by obtaining a complex field of a pilot optical signal for each propagation path, the complex field comprising an I (in-phase) component and a Q (quadrature) component corresponding to each propagation path. For each propagation path, an estimated phase error is determined directly from the I component and the Q component of the pilot optical signal. In one example, the estimated phase error is a relative phase error determined relative to the same propagation path. In another example, the estimated phase error comprises estimating over a data block size L in the pilot signal. And still another example, the estimated phase error comprises estimating over a data block size L in the pilot signal, which is selected to average out an effect of shot noise in an error calculation.

Next, the I and the Q components of each of the single optical data signals of the propagation paths are combined to obtain a recovered electrical signal for each propagation path by subtracting the estimated phase error determined from the pilot signal. The recovered electrical signal from each propagation path is coherently summed after removing a corresponding phase error.

In another example, a weighting factor is calculated for each propagation path, which is proportional to the magnitude of an electrical signal of the single optical data signal of the corresponding propagation path.

In another example, for each propagation path, the phase error is electronically removed in the received single optical data signal that is a result of travel through free space by subtracting the estimated phase error from a corresponding recovered electrical signal to remove the corresponding phase error from the corresponding recovered electrical signal and to produce a corrected signal for the propagation path. A weighting factor is calculated for the propagation path, which is proportional to a magnitude of the complex field of the propagation path. The coherently summing of the recovered electrical signal from each propagation path further comprises the steps of multiplying the corrected signal for the propagation path by the weighting factor for the propagation path to produce a weighted corrected signal for the propagation path. The weighted corrected signal for the path with the weighted corrected signals for the other paths are summed.

In yet another example, the single optical data signal is detected using an array of optical detectors to produce a corresponding plurality of complex electrical field signals. A plurality of relative phase errors between the complex electrical field signals is removed.

In still, another example for each propagation path, an estimated phase error relative to each of the other propagation paths is determined. The recovered signal from each propagation path is coherently summed by removing the corresponding estimated phase errors.

### BRIEF DESCRIPTION THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a diagram of a communication system of electronic wavefront correction for free-space optical communications, according to one aspect of the present invention;

FIG. 2 is a diagram of one embodiment of the receiver from FIG. 1, according to one aspect of the present invention;

FIG. 3 is a diagram of a coherent receiver, according to the prior art;

FIG. 4 is a diagram of a phase estimation algorithm for quadrature phase-shift keying (QPSK), according to the prior art;

FIG. 5 is a diagram of DSP-based electrical wavefront correction (EWC), according to the prior art;

FIG. 6 is a diagram of a 2-path free-space optical communication system in fiber, according to the prior art;

FIG. 7 is a graph of BER (bit-error ratio) versus signal power, according to the prior art;

FIG. 8 is a diagram of a 4×1 adaptive optics photonic integrated circuit (PIC), according to the prior art;

FIG. 9 is a diagram of a 4×1 adaptive optics photonic integrated circuit (PIC) in which each phase shifter is controlled by a different photocurrent, according to one aspect of the present invention;

FIG. 10 is a flow diagram of a first example of wavefront correction with monitoring per stage using the PIC in FIG. 9, according to one aspect of the invention;

FIG. 11 is a diagram of a mixed/coherently detected signal sent to an application-specific integrated circuit (ASIC) that performs the function of the photonic integrated circuit (PIC) in FIG. 9, according to one aspect of the present invention; and

FIG. 12 is a flow diagram of a second example of wavefront correction with digital implementation of a photonic integrated circuit for turbulence mitigation using the ASIC in FIG. 11, according to one aspect of the invention;

FIG. 13 is a flow diagram of a third example of wavefront correction using pilot phase estimation, according to one aspect of the invention;

FIG. 14 is a diagram of a computing device which can be used to implement various embodiments of systems and methods of electronic wavefront correction for free-space optical communications, according to one aspect of the present invention.

### DETAILED DESCRIPTION

### Non-Limiting Definitions

The terms “a”, “an” and “the” are intended to include the plural forms as well unless the context clearly indicates otherwise.

The phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “beam combiner” is a device that allows coherent beams to interfere with each other. It can be implemented by, but not limited to, reflective optics, refractive optics, diffractive optical elements, fiber optical devices, or a combination of such components.

The term “beam duplicator” is a device that generates two or more copies of incident light that have one or more prescribed parameters the same as the incident light, including wavelengths, spatial modes, polarizations, quadratures, and wave vectors. It can be implemented by, but not limited to, reflective optics, refractive optics, diffractive optical elements, fiber optical devices, or a combination of such components.

The term “beam splitter” is a device that can split a propagating light into two or more paths. It can be implemented by, but not limited to, reflective optics, refractive optics, diffractive optical elements, fiber optical devices, or a combination of such components.

The term “image” refers to a spatial pattern of physical light comprised of known colors of the light spectrum, which may or may not be visible to the human eye.

The term “light” is electromagnetic radiation that includes both visible and non-visible portions of the light spectrum.

### Acronyms Used in this Patent

ADC—Analog-to-Digital Conversion
AM—Amplitude Modulation
BER—Bit Error Ratio
BPF—Band Pass Filter
DSP—Digital Signal Processing
EDFA—Erbium-Doped Fiber Amplifier
EWC—Electrical Wavefront Correction
FSO—Free-Space Optical
HM—Half Mirror
I—In-phase
Q—In Quadrature
LO—Local Oscillator
MPLC—Multi-plane light conversion
NRZ BPSK—Non-Return-to-zero (NRZ) to Binary Phase-Shift-Keying (BPSK)
PBS—Polarize Beam Spitter
PC—Polarization Controller
PD—Phase Detector
PIC—Photonic Integrated Circuit
PM—Phase Modulation
PPM—Pulse-Position Modulation
PSK— Phase-Shift Keying
QWP—Quarter Wave Plate
VA—Variable Attenuator
WDM—Wavelength-Division Multiplexing

### BACKGROUND

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

### Overview of Free Space Optical Communications

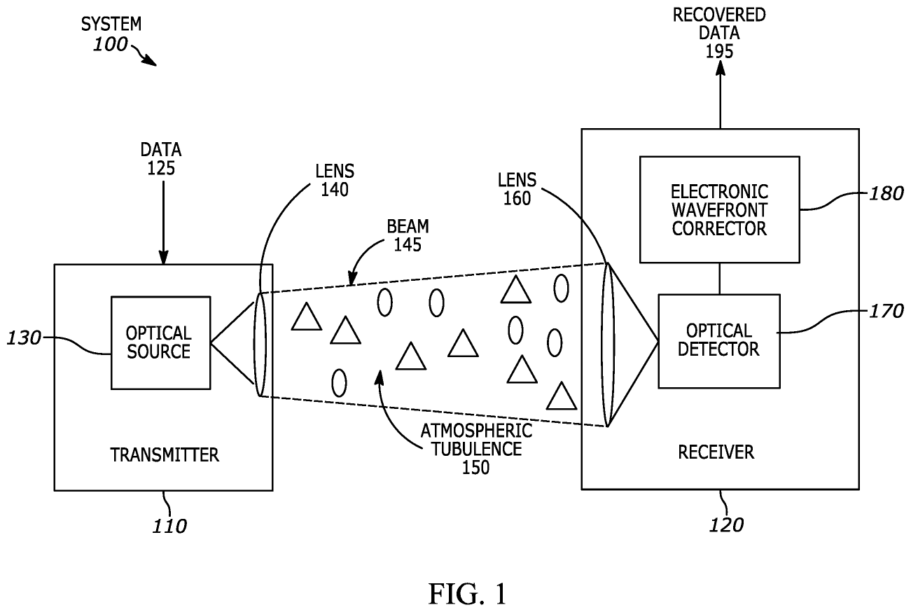

FIG. 1 is a diagram of a communication system, including an embodiment of a system and a method of electronic wavefront correction for free-space optical communications. System 100 includes a transmitter 110 and a receiver 120 in communication through free space. Although not illustrated, system 100 may also include various components such as amplifiers, repeaters, multiplexers, etc., as understood by a person of ordinary skill in the art.

Transmitter 110 receives data 125, which is used to modulate an optical source 130. The output of optical source 130 is focused by a lens 140 and then propagated into the atmosphere as a beam (135).

Beam 135 travels through atmospheric turbulence 150 caused by wind and temperature gradients. Turbulence 150 includes pockets of air with rapidly varying densities and, therefore, fast-changing indices of optical refraction. These air pockets act like prisms and lenses with time-varying properties. The constantly changing index of refraction causes relatively large displacements of the transmitted beam (beam wander), and also causes the beam to spread out in transit, reducing the energy on the central axis. In addition, the changes in refraction cause some parts of the beam to slow more than others, distorting the uniform wavefronts that exited the transmitter. These small, random phase changes cause constructive and destructive interference.

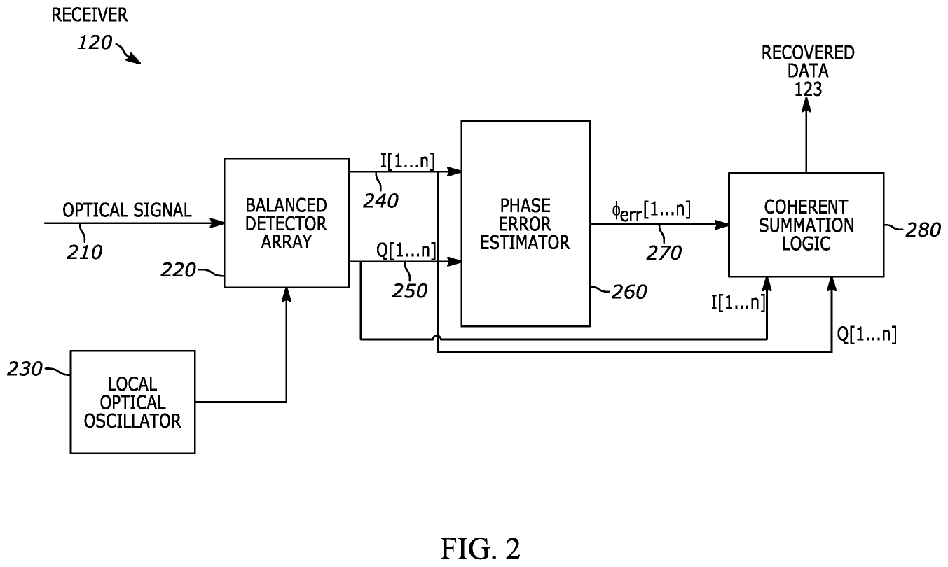

After passing through turbulence 150, distorted beam 135 is received at receiver 120 and focused by lens 160. The focused beam is provided to an optical detector 170, which converts the optical signal representing the wavefront to an electrical signal representing the wavefront. The electrical signal includes phase information. Using this phase information, an electronic wavefront corrector 180 processes the signal electronically to remove or correct for the distortion produced by turbulence 150. After correction, receiver 120 further processes the signal electronically to recover the originally transmitted data, producing received data 185. Electronic wavefront corrector 180 will now be described in further detail in connection with FIGS. 2-11.

FIG. 2 is a diagram of receiver 120 from FIG. 1, showing further details of the operation of electronic wavefront corrector 180. By using a coherent receiver to obtain the complex field (amplitude and phase) of the wavefront, correction of the wavefront is performed in the electronic rather than the optical domain.

After being focused by lens 160, the received optical signal 210 is provided to an array of N-balanced photodetectors (220). Balanced detector array 220 also receives an input from a local optical oscillator 230 (e.g., a tunable laser). Balanced detector array 220 measures the interference pattern produced by the combination of optical signal 210 and local optical oscillator 230, including in-phase and quadrature components.

The series of in-phase components I[1 . . . N] (240) and quadrature components Q[1 . . . N] (250) produced by balanced detector array 220 are provided to phase error estimator 260, which determines an estimation of the phase error ϕₑᵣ [1 . . . N] (270) in the received signal due to turbulence 150.

A coherent summation block 280 receives the phase elements 240 and 250 and the estimated phase error 270. Coherent summation block 280 combines individual I and Q phase elements in order to recover an electrical signal (corresponding to the optical signal) as it is received at multiple locations on array 220.

Referring to FIG. 2, estimated phase error ϕₑᵣᵣ[1 . . . N] (270) contains estimated phase errors for each propagation path relative to the first path. The estimated phase error array 270 thus provides complete information about the wavefront distortion of the received optical signal. Coherent summation block 280 then coherently sums the recovered signal from each propagation path after removing the corresponding estimated phase error ϕₑᵣᵣ[j].

### Electronic Wavefront Correction [5]

### Coherent Optical Communication

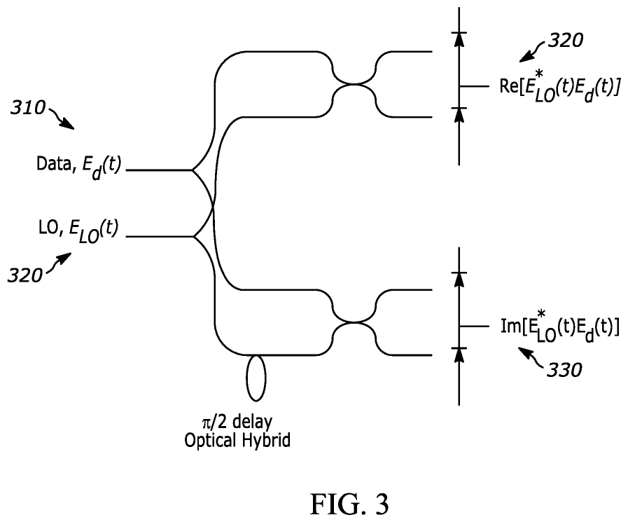

In coherent optical communication, information is encoded onto the electric field of the lightwave, and decoding entails the direct measurement of the complex electric field. To measure the complex electric field of the lightwave, the incoming data signal (after fiber transmission) E_{d}(t) 310 interferes with a local oscillator (LO) E_{LO}(t) 330 in an optical 90° hybrid as shown in FIG. 3. If the balanced detectors in the upper branches 320 measure the real part of the input data signal, the lower branches 340, with the LO phase delayed by 90°, will measure the imaginary part of the input data signal. For reliable measurement of the complex field of the data signal, the LO must be locked in both the phase and polarization with the incoming data.

Phase and polarization management turned out to be the major obstacles to the practical implementation of conventional coherent receivers. The state of polarization of the lightwave is scrambled in the fiber. Dynamic control of the state of polarization of the incoming data signal is required so that it matches that of the LO. Dynamic polarization controllers are bulky and expensive. For wavelength-division multiplexing (WDM) systems, each channel needs a dedicated dynamic polarization controller. The difficulty in polarization management alone severely limits the practicality of coherent receivers. Polarization for some FSO applications, especially for fixed point-to-point FSO links. However, phase locking is challenging as well. All coherent modulation formats with phase encoding are carrier-suppressed. Therefore, conventional techniques such as injection locking and optical phase-locked loops cannot be directly used to lock the phase of the LO. Instead, decision-directed phase-locked loops must be employed [4]. At high symbol rates, the delays allowed in the phase-locked loop are so small that it becomes impractical.

Fortunately, both phase and polarization management can be realized in the electrical domain using digital signal processing (DSP). A digital carrier phase estimation is described because this is more relevant for FSO.

### Digital Carrier Phase Estimation

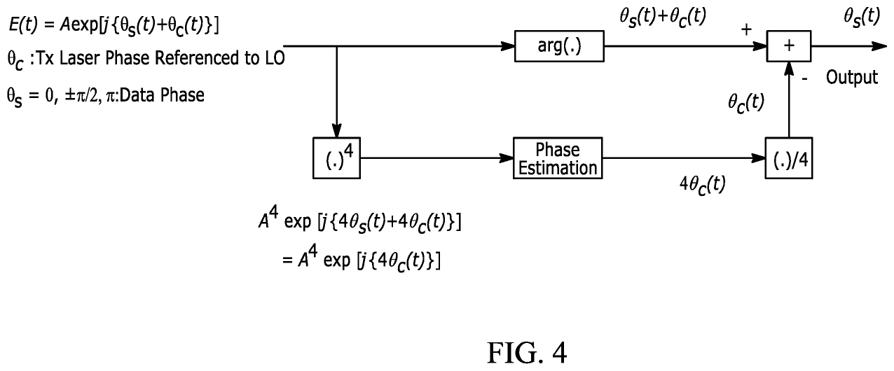

This powerful DSP technique allows coherent optical communication without the need for hardware optical phase-locked loops. Phase locking in the hardware domain can be replaced by phase estimation in the software/DSP domain. An algorithm for DSP-based phase estimation is schematically shown in FIG. 4. A quadrature phase-shift keying (QPSK) signal is used as an example in which the signal can be represented as

$$E ( t ) = A exp [ j \{ {θ}_{s} ( t ) + {θ}_{c} ( t ) \} ] \qquad ( 1 )$$

where θ_{c}(t) is the phase of the transmitter laser referenced to the LO and the data phase takes on four values θₛ=0,±π/2,π. In order to estimate the phase of the transmitter θ_{c} using DSP, the received signal has to be detected coherently to obtain its real and imaginary parts as shown in FIG. 4 [4]. The received complex signal is then digitized using analog-to-digital conversion (ADC) and processed in the software domain using DSP. When the received signal is raised to the power of 4 as shown in FIG. 3, this is represented by A⁴exp[j{4θₛ(t)+4θ_{c}(t)}]=A⁴ exp[j{4θ_{c}(t)}], which strips off the data phase. The phase of the transmitter can then be computed and subtracted from the phase of the received signal to recover the data phase as shown in FIG. 3. Such a feed-forward phase estimation scheme lends itself well to real-time digital implementation.

FSO Communication Receiver with EWC

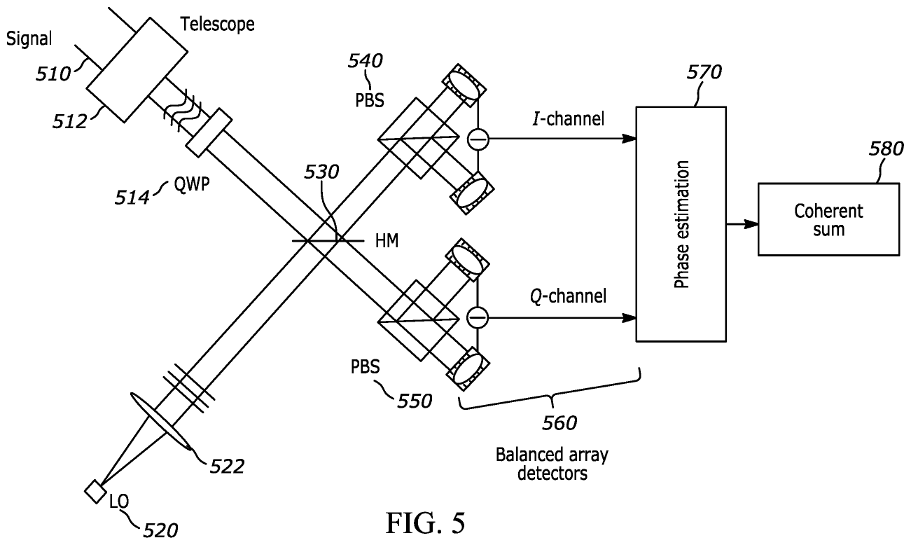

The disclosed coherent FSO communication receiver with electrical wavefront correction (EWC) is schematically shown in FIG. 5. Two optical paths are shown. The first optical path is from signal 510, passing through the telescope 512 and quarter wave plate (QWP) 514, as shown. The second optical path is from local oscillator 520 passing through lens 522 to provide an interference at half mirror 520 with the signal. The interference pattern of the incoming signal and a local oscillator (LO) is measured both in in-phase (I) and in quadrature (Q) using 2-balanced arrayed detectors 560 after passing through Polarize Beam Splitter (PBS) 540 and 550 as shown. The corresponding elements in the I and Q balanced detectors can be combined to produce the complex interference of the signal and LO at a specific location of the aperture corresponding to different propagation paths. The phase error due to atmospheric propagation can then be estimated [see below]. Phase estimation 570 of all aperture locations provides complete information about wavefront aberration. The wavefront aberration can then be subtracted from the detected signal, yielding a coherent, constructive summation 580 over all locations of the aperture.

Note that phase noise accumulated along the propagation path is indistinguishable from the LO and can also be estimated. Thus, when an array of coherent homodyne receivers are employed at the focal plane for FSO, the difference in the estimated “carrier phase” will be equal to the wavefront distortion due to atmospheric turbulence. Alternatively, the relative phase noise due to wavefront distortion between two propagation paths n and m can be estimated directly:

$${ϕ}_{n , m} = arg {\sum }_{k}^{L} \frac{{Z}_{n} ( k )}{{Z}_{m} ( k ) / \vert {Z}_{m} ( k ) \vert} \qquad ( 2 )$$

where Zₙ(k) the complex electric field is measured in nth propagation path at the kth sampling time, and L is the size of the data block. L is chosen to average out the effect of shot noise in this calculation. L can be much larger compared to the block size for carrier phase noise estimation since the relative phase noise due to wavefront distortion varies much slower compared to the carrier phase noise due to the finite beat linewidth of the transmitter laser and the local oscillator [4]. However the time window of L should be small compared to the time-scale of wavefront distortion, which is on the order of milliseconds due to atmospheric turbulence. The signal from each propagation path can be coherently added by removing relative phase noise. Subsequently, the carrier phase noise can be estimated for data demodulation according to reference [4].

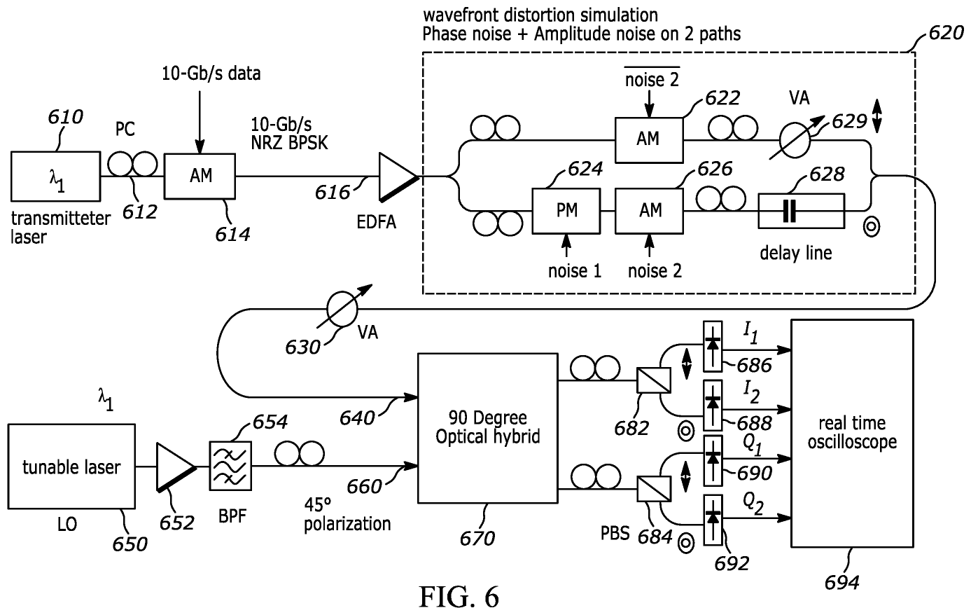

FIG. 6 shows the experimental setup simulating a 2-path free-space optical communication system in fiber [6, 7]. Two paths are shown. Laser transmitter signal path 610 with polarization controller 612 through amplitude modulations 614 using 10-Gb/s to produce Non-Return-to-zero (NRZ) to Binary Phase-Shift-Keying (BPSK) 614 feed into Erbium-Doped Fiber Amplifier (EDFA) 616 as shown. To simulate the effect of the wavefront distortion in free-space, which causes phase and amplitude noise in each propagation path, two intensity modulators 622, 626, and one phase modulator 624 were used as shown in a dotted-boxed area 620 in FIG. 6. Two paths 640, 660 were multiplexed using two orthogonal polarizations. A 20-kHz sinusoidal intensity modulation with a depth of about 7.5 was added in each path. The first path includes a variable attenuator (VA) 629 as shown. The intensity modulations were out of phase between the two paths so that the combined power after polarization multiplexing was almost constant. In addition to this, a 20-kHz phase modulation 624 with a peak-to-peak amplitude of about 2.9 radians was added to the second path and delay line 628. The local oscillator power was 11 dBm at optical hybrid. The beat linewidth of the transmitter laser 610 and the LO 650 was about 200 kHz at 1550 nm. The polarization of the local oscillator was properly controlled through bandpass filter 654 so that the same power was assigned to each path 640, 660. After the 90-degree optical hybrid 670, two paths were separated by polarization beam splitters 682, 684 that generated two sets of in-phase and quadrature-phase signals. In the experiments, 4 single-end detectors 686, 688, 690, 692 were used. The data were acquired using a real-time oscilloscope 694 at 20 Gs/s and processed offline.

In the experiment, the weighting factor is calculated block-wise to average out the effect of shot noise according to

$${w}_{m} = {\sum }_{k}^{L} {\vert {Z}_{m} ( k ) \vert}^{r} / {\sum }_{n}^{M} {\sum }_{k}^{L} {\vert {Z}_{n} ( k ) \vert}^{r} \qquad ( 3 )$$

where ‘r=1’ is optimal according to (2).

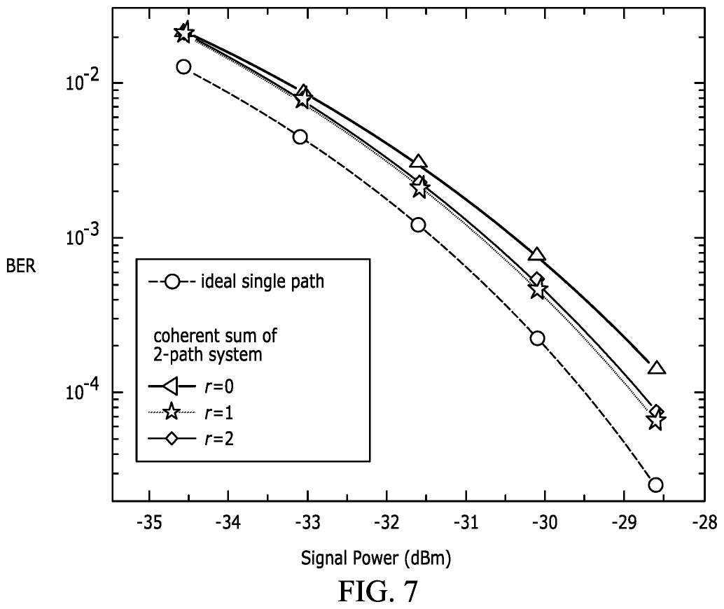

FIG. 7 shows the BER as a function of the total input signal power. The ideal single path performance was measured using only one of the paths when all the signal power falls to this path. The performance of each of the two paths was comparable. The penalty of the coherently combined signal after wavefront correction using DSP was about 0.5 dB, for the r=1 case. The main cause is believed to be the residual amplitude modulation after polarization multiplexing of two paths, which was about 3-5% in power. In addition, there was inter-symbol interference due to non-perfect matched filtering in the system.

### On-Chip Adaptive Optics

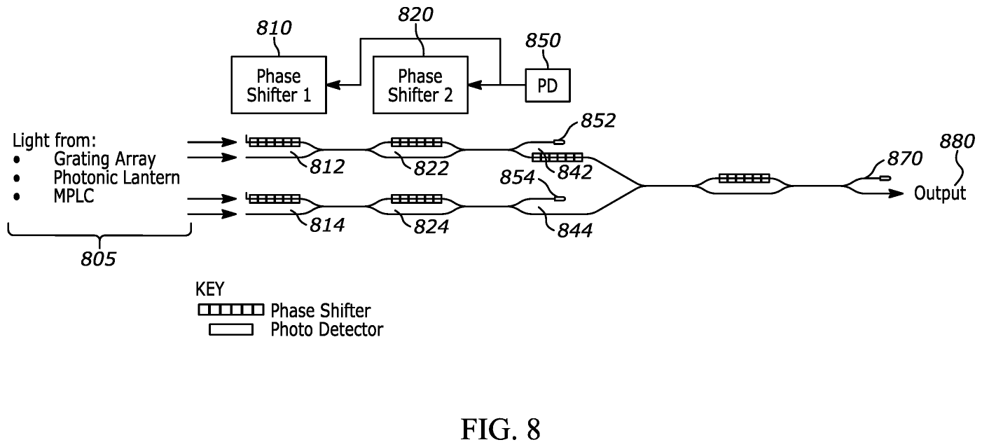

Recently, there have been efforts to use on-chip adaptive optics for turbulence mitigation [6], typically using a photonic integrated circuit (PIC) as shown in FIG. 8 for the example of combining 4-path of light 805 received from a distorted wavefront using an array of gratings, or a photonic lantern, or a multi-plane light conversion (MPLC) mode demultiplexer. The adaptive PICs realizes coherent combining using log₂N stages, each stage having N/2/i 2 to 1 combiners, where N is the total number of inputs and i stands for the ith stage. Each 2 to 1 combiner has two stages 810, 820. For the case of 4 to 1 combining, we need 2 (2 to 1) combiners in the first stage. to realize (4 to 2) 812, 814, 822, 824, and then (2 to 1) combining 842, 844. For each combiner, there are two 2×2 couplers and 2 phase shifters, as shown with reference to key as well as a monitor phase detector (PD) 850. at the end of each combiner (852, 854 are PDs for the two combiners, respectively, in the first stage). The monitor PD signal 870 is used to control the two phase shifters so that its output 880 is maximized. One of the shortcomings of the schematic in FIG. 8 is that one PD signal must control both phase shifters, which can pose algorithm challenges and device malfunction.

Adaptive Optics PIC for Wavefront Correction with Monitoring Per Stage

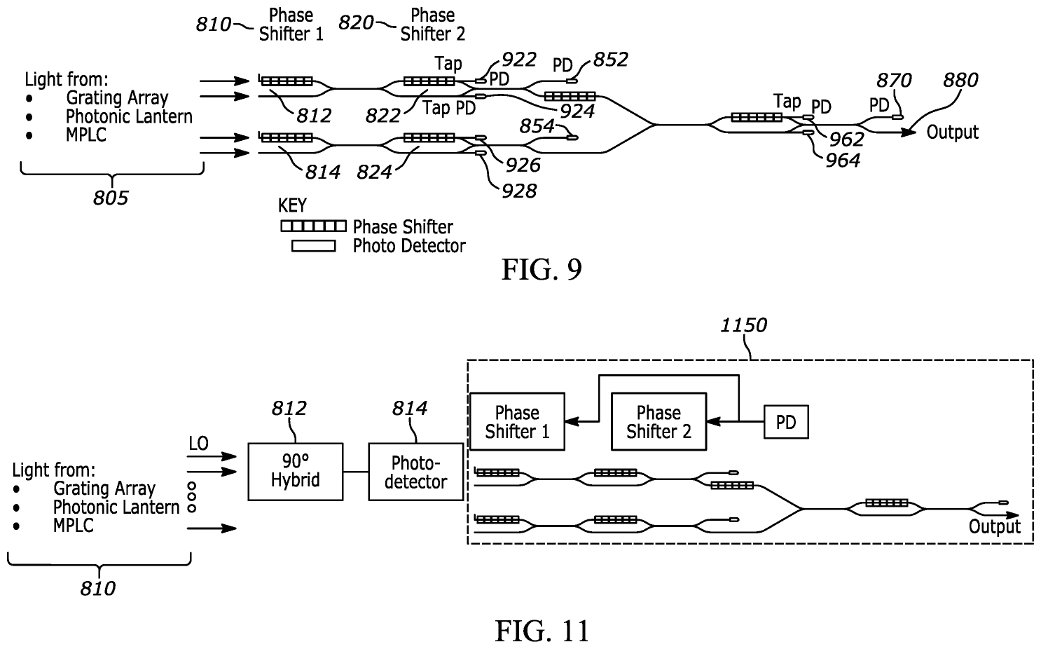

Here, the design in FIG. 8 is modified to add monitoring PDs 922, 924, 926, 928, 962, 964 for each phase shifter, as shown in FIG. 9.

FIG. 9 Schematic of a 4×1 adaptive optics PIC for wavefront correction in which each phase shifter 810, 820 is controlled by a different photocurrent: balanced photocurrent 922, 924 for Phase Shifter 1 812, and photocurrent of a single PD 852, for Phase Shifter 2 822, as shown. Similarly, (926, 928) for 814 and 954 for 824, which will prevent device malfunction. It is important to note that this claimed invention works for either coherent or incoherent optical communications.

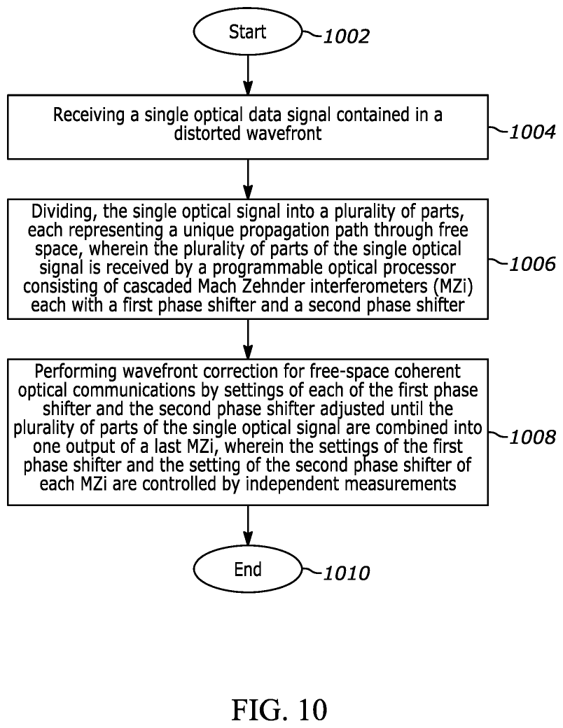

FIG. 10 is a flow diagram of a first example of wavefront correction with monitoring per stage using the PIC in FIG. 9. The process starts with step 1002 and immediately proceeds to step 1004.

In step 1004, a single optical data signal contained in a distorted wavefront is received. The process continues to step 1006.

In step 1006, the single optical signal is divided into a plurality of parts, each representing a unique propagation path through free space, wherein the plurality of parts of the single optical signal is received by a programmable optical processor consisting of cascaded Mach-Zehnder interferometers (MZi), each with a first phase shifter and a second phase shifter. The process continues to step 1008.

In one example wherein the settings of the first phase shifter is controlled by balancing the outputs of a first 2×2 coupler, and the settings of the second phase shifter are controlled by minimizing the outputs of an undesired port of a second 2×2 coupler.

In another example, the first phase shifter and the second phase shifter are thermal phase shifters.

In step 1008, the settings of each of the first phase shifter and the second phase shifter is adjusted until the plurality of parts of the single optical signal are combined into one output of a last MZi, wherein the settings of the first phase shifter and the setting of the second phase shifter of each MZi are controlled by independent measurements. The process continues to step 1010, in which the flow ends.

### Digital Implementation of Photonic Integrated Circuit (PIC) for Turbulence Mitigation

Another efficient way of doing turbulence mitigation is to realize the function of the PIC in FIG. 9 in the digital domain. To do this, the amplitude and phase of light is preserved in the digital domain. This is done by mixing the received light from the grating array/photonic lantern/MPLC mode demultiplexer 810 with a local oscillator (LO) for each path. The mixed signal will then be sent into digital circuits, i.e., an application-specific integrated circuit (ASIC) that performs the function of the PIC in FIG. 10. The box represents this in drawn in broken lines in FIG. 11. In the box represented in broken lines, the functions of the splitters and phase shifters are carried out via digital signal processing.

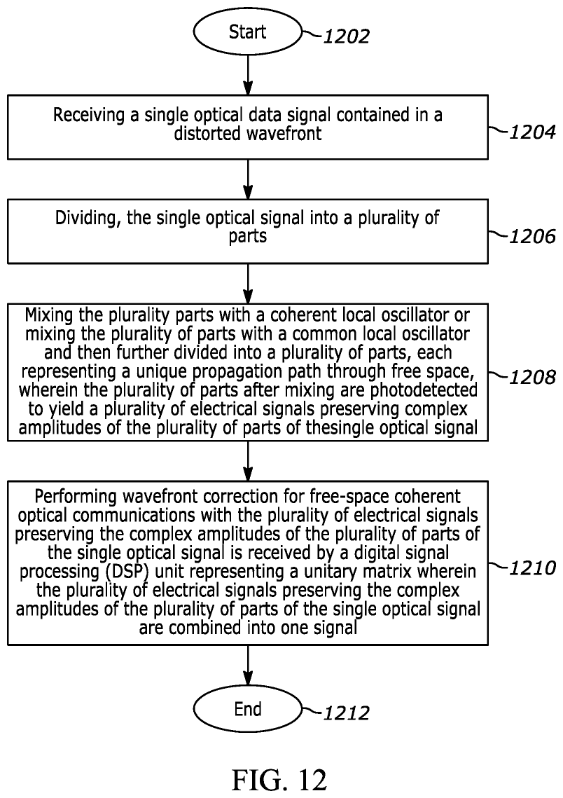

FIG. 12 is a flow diagram of a second example of wavefront correction with a digital implementation of a photonic integrated circuit for turbulence mitigation using the ASIC in FIG. 11. The process starts with step 1202 and immediately proceeds to step 1204.

In step 1204, a single optical signal contained in a distorted wavefront is received. The process continues to step 1206.

In step 1206, the single optical signal is divided into a plurality of parts. The process continues to step 1208.

In step 1208, the plurality of parts (optical) is mixed with a coherent local oscillator or is mixed with a common local oscillator, resulting a plurality of electrical signal proportional to the complex amplitude of each optical part, each representing a unique propagation path through free space, wherein the plurality of parts after mixing are photodetected to yield a plurality of electrical signals preserving complex amplitudes of the plurality of parts of the single optical signal. The process continues to step 1210.

In step 1210, the plurality of electrical signals preserving the complex amplitudes of the plurality of parts of the single optical signal is received by a digital signal processing (DSP) unit representing a unitary matrix wherein the plurality of electrical signals preserving the complex amplitudes of the plurality of parts of the single optical signal are combined into one signal. The process continues to step 1212, in which the flow ends.

In one example, the DSP unit is a digital representation of a programmable optical processor consisting of cascaded Mach-Zehnder Interferometers (MZi), each with a first phase shifter and a second phase shifter. The settings of the first phase shifter and the second phase shifter are adjusted until the plurality of electrical signals preserving complex amplitudes of the plurality of parts of the single optical signal is combined into one output of a last MZi, wherein the settings of the first phase shifter and the setting of the second phase shifter of each MZi are controlled by independent measurements.

The settings of the first phase shifter are controlled by balancing the outputs of a first 2×2 coupler, and the settings of the second phase shifter are controlled by minimizing the outputs of an undesired port of a second 2×2 coupler.

### Electronic Wavefront Correction Using Pilot Phase Estimation

Referring to Prior Art 1 [5], disclose a method to realistically perform electronic wavefront correction using phase estimation. It is noticed that if phase estimate is performed at the data symbol rate, then each sub-aperture must have enough power to enable phase estimation. However, most likely, there is not enough power in each sub-aperture to do so; otherwise, one can simply recover the data from the signal in one sub-aperture.

Another embodiment is to send a pilot signal at a much lower baud rate than the data itself. That way, one can filter out the pilot signal and perform phase estimation using the pilot signal. Since the pilot is at a much lower symbol rate, a small amount of power may be added at the transmitter for the phase estimation based on the pilot signal to enable phase estimation based on the pilot signal.

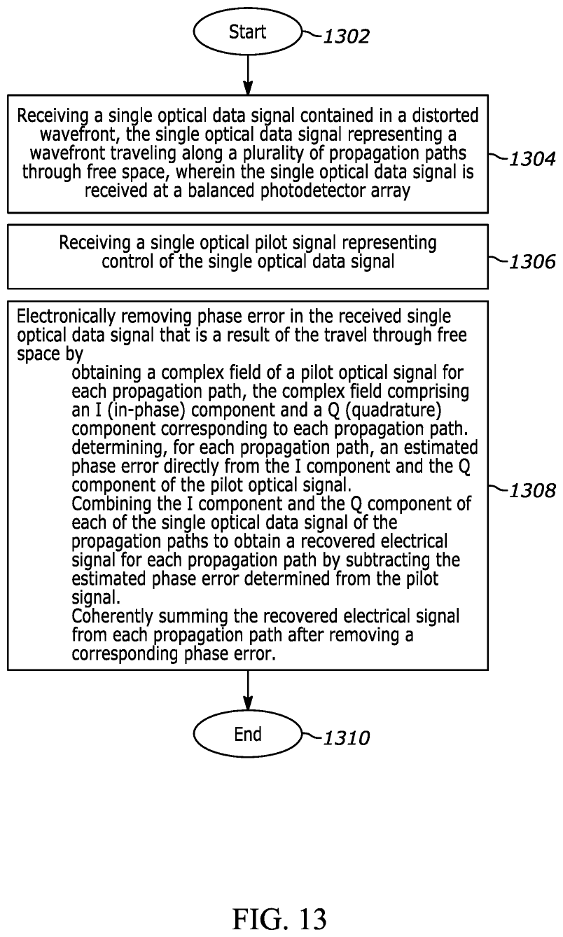

FIG. 13 is a flow diagram of a third example of wavefront correction using pilot phase estimation. The process starts with step 1302 and immediately proceeds to step 1304.

In step 1304, according to one aspect of the invention, a single optical data signal is received representing a wavefront traveling along a plurality of propagation paths through free space, wherein the single optical data signal is received at a balanced photodetector array. The process continues to step 1306.

In one example, the single optical pilot signal is sent with low additional power as compared with the single optical data signal. In another example, the single optical pilot signal is sent at a lower baud rate than the single optical data signal.

Optionally, a weighting factor is calculated for each propagation path, which is proportional to the magnitude of an electrical signal of the single optical data signal of the corresponding propagation path.

In step 1306, a single optical pilot signal is received for each aperture/propagation path. The single optical pilot signal represents control of the single optical data signal in that aperture/propagation path. The process continues to step 1308.

In step 1308, the phase error in the received single optical data signal that is a result of the travel through free space is electronically removed by:
obtaining a complex field of a pilot optical signal for each propagation path, the complex field comprising an I (in-phase) component and a Q (quadrature) component corresponding to each propagation path;
determining, for each propagation path, an estimated phase error directly from the I component and the Q component of the pilot optical signal;
combining the I component and the Q component of each of the single optical data signal of the propagation paths to obtain a recovered electrical signal for each propagation path by subtracting the estimated phase error determined from the pilot signal; and
coherently summing the recovered electrical signal from each propagation path after removing a corresponding phase error.

In one example, each of the estimated phase errors is a relative phase error determined relative to the same propagation path.

Further, in another example, the estimated phase error is estimated over a data block size L in the pilot signal. For example, the estimated phase error may be estimated over a data block size L in the pilot signal, which is selected to average out an effect of shot noise in an error calculation.

In another example, for each propagation path, the phase error is removed electronically in the received single optical data signal by performing:
subtracting the estimated phase error from a corresponding recovered electrical signal to remove the corresponding phase error from the corresponding recovered electrical signal and to produce a corrected signal for the propagation path;
calculating a weighting factor for the propagation path, which is proportional to the magnitude of the complex field of the propagation path;
wherein the step of coherently summing the recovered electrical signal from each propagation path further comprises the steps of multiplying the corrected signal for the propagation path by the weighting factor for the propagation path to produce a weighted corrected signal for the propagation path; and
summing the weighted corrected signal for the path with the weighted corrected signals for the other paths.

The process may include detecting the single optical data signal in an array of optical detectors to produce a corresponding plurality of complex electrical field signals and
removing a plurality of relative phase errors between the complex electrical field signals.

The process may also include determining, for each propagation path, an estimated phase error relative to each of the other propagation paths and coherently summing the recovered signal from each propagation path by removing the corresponding estimated phase errors.

The process continues to step 1310, in which the flow ends.

### Computing Device

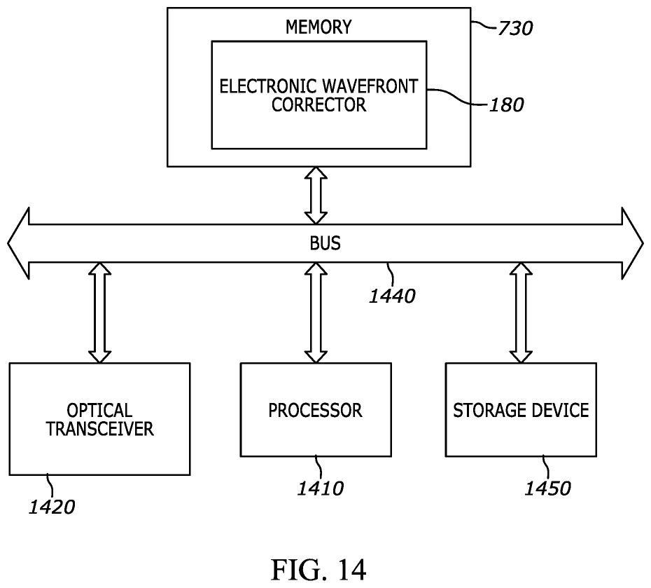

FIG. 14 is a hardware block diagram of a computing device 1400, which can be used to implement various embodiments of systems and methods of electronic wavefront correction for free-space optical communications. Computing device 1400 contains a number of components that are well known in the computer arts, including a processor 1410 (e.g., microprocessor, digital signal processor, microcontroller, digital signal controller), an optical transceiver 1420, and memory 1430. These components are coupled via a bus 1440. Some embodiments also include a storage device 1450, such as non-volatile memory or a disk drive. In the embodiment of FIG. 14, the electronic wavefront corrector (as described above) 180 resides in memory 1430 as instructions which, when executed by processor 1410, implement systems and methods of electronic wavefront correction for free-space optical communications. Omitted from FIG. 14 are a number of conventional components that are unnecessary to explain the operation of computing device 1400.

In other embodiments (not shown), the electronic wavefront corrector 180 is implemented in hardware, including, but not limited to, a programmable logic device (PLD), a programmable gate array (PGA), a field programmable gate array (FPGA), an application-specific integrated circuit (ASIC), a system on chip (SoC), and a system in package (SiP).

Electronic wavefront corrector 180, or both can be embodied in any computer-readable medium for use by or in connection with an instruction execution system, apparatus, or device. Such instruction execution systems include any processor-containing system or other system that can fetch and execute instructions. In the context of this disclosure, a “computer-readable medium” can be any means that can contain or store the instructions for use by the instruction execution system. The computer-readable medium can be, for example, but not limited to, a system or that is based on electronic, magnetic, optical, electromagnetic, or semiconductor technology.

Specific examples of a computer-readable medium using electronic technology would include (but are not limited to) the following: random access memory (RAM); read-only memory (ROM); and erasable programmable read-only memory (EPROM or Flash memory). A specific example using magnetic technology includes (but is not limited to) a portable computer diskette. Specific examples of using optical technology include (but are not limited to) compact disks (CDs) and digital video disks (DVDs).

### Non-Limiting Examples

Although specific embodiments of the invention have been discussed, those having ordinary skill in the art will understand that changes can be made to the specific embodiments without departing from the scope of the invention. The scope of the invention is not to be restricted, therefore, to the specific embodiments, and it is intended that the appended claims cover any and all such applications, modifications, and embodiments within the scope of the present invention.

It should be noted that some features of the present invention may be used in one embodiment thereof without use of other features of the present invention. As such, the foregoing description should be considered as merely illustrative of the principles, teachings, examples, and exemplary embodiments of the present invention and not a limitation thereof.

Also, these embodiments are only examples of the many advantageous uses of the innovative teachings herein. In general, statements made in the specification of the present application do not necessarily limit any of the various claimed inventions. Moreover, some statements may apply to some inventive features but not to others.

The description of the present invention has been presented for purposes of illustration and description and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

### INCORPORATED REFERENCES

The following publications are each incorporated by reference in their entirety and listed in the Information Disclosure:
[1] Kaufmann, J.: “Performance limits of high-rate space-to-ground optical communications through the turbulent atmospheric channel”, Proc. Of SPIE, 1995, Vol. 238, pp. 171-182.
[2] Vilnrotter, V., Srinviasan, M.: “Adaptive detector arrays for optical communications receivers”, IEEE Trans. On Commun., 2002, Vol. 50, pp. 1091-1097.
[3] Fernandez, M., Vilnrotter, V.: “Coherent optical receiver for PPM signals received through atmospheric turbulence: Performance analysis and preliminary experimental results”, Proc. of SPIE, 2004, Vol. 5338, pp. 151-162.
[4] Kikuchi, K.: “Coherent Detection of Phase-Shift Keying Signals Using Digital Carrier-Phase Estimation”, OTuI4, OFC 2006.
[5] U.S. Pat. No. 9,374,158B2, Electronic wavefront correction for free-space optical communications.
[6] Francesco Morichetti et al., “Mitigation of Atmospheric Turbulence in an Optical Free Space Link With an Integrated Photonic Processor,” Proceedings of the Optical Fiber Communications Conference, Paper W3I.7, San Diego, CA, 2023.

What is claimed is:

1. A method comprising:
receiving a single optical data signal contained in a distorted wavefront, wherein a single optical signal is divided into a plurality of parts, each representing a unique propagation path through free space, wherein the plurality of parts of the single optical signal is received by a programmable optical processor consisting of cascaded Mach-Zehnder Interferometers (MZi) each with a first phase shifter and a second phase shifter; and
adjusting settings of each of the first phase shifter and the second phase shifter until the plurality of parts of the single optical signal are combined into one output of a last MZi, wherein the settings of the first phase shifter and the setting of the second phase shifter of each MZi are controlled by independent measurements.

2. The method of claim 1, wherein the settings of the first phase shifter is controlled by balancing outputs of a first 2×2 coupler, and the settings of the second phase shifter are controlled by minimizing outputs of an undesired port of a second 2×2 coupler.

3. The method of claim 1, wherein the first phase shifter and the second phase shifter are thermal phase shifters.

4. A method comprising:
receiving a single optical signal contained in a distorted wavefront, wherein the single optical signal is divided into a plurality of parts and then mixed with a coherent local oscillator or is mixed with a common local oscillator and then further divided into a plurality of parts, each representing a unique propagation path through free space, wherein the plurality of parts after mixing are photodetected to yield a plurality of electrical signals preserving complex amplitudes of the plurality of parts of the single optical signal; and
wherein the plurality of electrical signals preserving the complex amplitudes of the plurality of parts of the single optical signal is received by a digital signal processing (DSP) unit representing a unitary matrix wherein the plurality of electrical signals preserving the complex amplitudes of the plurality of parts of the single optical signal are combined into one signal.

5. The method of claim 4, wherein the DSP unit is a digital representation of a programmable optical processor consisting of cascaded Mach-Zehnder Interferometers (MZi), each with a first phase shifter and a second phase shifter; and
adjusting settings of the first phase shifter and the second phase shifter until the plurality of electrical signals preserving complex amplitudes of the plurality of parts of the single optical signal is combined into one output of a last MZi, wherein the settings of the first phase shifter and the setting of the second phase shifter of each MZi are controlled by independent measurements.

6. The method of claim 5, wherein the settings of the first phase shifter are controlled by balancing outputs of a first 2×2 coupler, and the settings of the second phase shifter are controlled by minimizing outputs of an undesired port of a second 2×2 coupler.

7. A method comprising:
receiving a single optical data signal representing a wavefront traveling along a plurality of propagation paths through free space, wherein the single optical data signal is received at a balanced photodetector array;
receiving a single optical pilot signal representing control of the single optical data signal; and
electronically removing phase error in the received single optical data signal that is a result of the travel through free space by:
obtaining a complex field of a pilot optical signal for each propagation path, the complex field comprising an I (in-phase) component and a Q (quadrature) component corresponding to each propagation path;
determining, for each propagation path, an estimated phase error directly from the I component and the Q component of the pilot optical signal;
combining the I component and the Q component of each of the single optical data signal of the propagation paths to obtain a recovered electrical signal for each propagation path by subtracting the estimated phase error determined from the pilot signal; and
coherently summing the recovered electrical signal from each propagation path after removing a corresponding phase error.

8. The method of claim 7, wherein the single optical pilot signal is sent with low additional power as compared with the single optical data signal.

9. The method of claim 8, wherein the single optical pilot signal is sent at a lower baud rate as compared with the single optical data signal.

10. The method of claim 7, further comprising
calculating a weighting factor for each propagation path which is proportional to a magnitude of an electrical signal of the single optical data signal of the corresponding propagation path.

11. The method of claim 7, wherein each of the estimated phase errors is a relative phase error determined relative to the same propagation path.

12. The method of claim 7, wherein the determining of the estimated phase error comprises estimating over a data block size L in the pilot signal.

13. The method of claim 7, wherein the determining of the estimated phase error comprises estimating over a data block size L in the pilot signal, which is selected to average out an effect of shot noise in an error calculation.

14. The method of claim 7, wherein the electronically removing phase error in the received single optical data signal that is a result of travel through free space further comprises:
for each propagation path:
subtracting the estimated phase error from a corresponding recovered electrical signal to remove the corresponding phase error from the corresponding recovered electrical signal and to produce a corrected signal for the propagation path;
calculating a weighting factor for the propagation path, which is proportional to a magnitude of the complex field of the propagation path;
wherein the step of coherently summing the recovered electrical signal from each propagation path further comprises the steps of multiplying the corrected signal for the propagation path by the weighting factor for the propagation path to produce a weighted corrected signal for the propagation path; and
summing the weighted corrected signal for the path with the weighted corrected signals for the other paths.

15. The method of claim 7, further comprising:
detecting the single optical data signal in an array of optical detectors to produce a corresponding plurality of complex electrical field signals; and
removing a plurality of relative phase errors between the complex electrical field signals.

16. The method of claim 7, further comprising:
determining, for each propagation path, an estimated phase error relative to each of the other propagation paths; and
coherently summing the recovered signal from each propagation path by removing the corresponding estimated phase errors.

17. An apparatus comprising:
an optical receiver configured to coherently receive an optical wavefront of a single optical signal traveling along a plurality of propagation paths through free space, the optical wavefront representing a data signal, the optical receiver comprising an array of detectors, each detector configured to receive the wavefront of the single optical signal along a corresponding one of the propagation paths; and
an electronic wavefront corrector configured to correct relative phase differences between the wavefronts of the single optical signal received at the array of detectors, wherein the electronic wavefront corrector is further configured to, for each propagation path
received by a programmable optical processor consisting of cascaded Mach-Zehnder Interferometers (MZi) each with a first phase shifter and a second phase shifter; and
adjusting settings of each of the first phase shifter and the second phase shifter until the plurality of paths of the single optical signal are combined into one output of a last MZi, wherein the settings of the first phase shifter and the setting of the second phase shifter of each MZi are controlled by independent measurements.

18. The apparatus of claim 17, wherein the settings of the first phase shifter are controlled by balancing outputs of a first 2×2 coupler and the settings of the second phase shifter is controlled by minimizing outputs of an undesired port of a second 2×2 coupler.

19. An apparatus comprising:
an optical receiver configured to coherently receive an optical wavefront of a single optical signal traveling along a plurality of propagation paths through free space, the optical wavefront representing a data signal, the optical receiver comprising an array of detectors, each detector configured to receive the wavefront of the single optical signal along a corresponding one of the propagation paths; and
an electronic wavefront corrector configured to correct relative phase differences between the wavefronts of the single optical signal received at the array of detectors, wherein the electronic wavefront corrector is further configured to, for each propagation path
mix with a common local oscillator and then further divided into a plurality of parts, each representing a unique propagation path through free space, wherein the plurality of parts after mixing are photodetected to yield a plurality of electrical signals preserving complex amplitudes of the plurality of parts of the single optical signal; and
wherein the plurality of electrical signals preserving the complex amplitudes of the plurality of parts of the single optical signal is received by a digital signal processing (DSP) unit representing a unitary matrix wherein the plurality of electrical signals preserving the complex amplitudes of the plurality of parts of the single optical signal are combined into one signal.

20. The system of claim 19, wherein the DSP unit is a digital representation of a programmable optical processor consisting of cascaded Mach-Zehnder Interferometers (MZi) each with a first phase shifter and a second phase shifter; and
adjust settings of the first phase shifter and the second phase shifter until the plurality of electrical signals preserving complex amplitudes of the plurality of parts of the single optical signal is combined into one output of a last MZi, wherein the settings of the first phase shifter and the setting of the second phase shifter of each MZi are controlled by independent measurements.
